(19) United States
(12) Patent Application Publication
(10) Pub. No.: US 2002/0142091 A1
(43) Pub. Date: Oct. 3, 2002

(54) Hog-hide dog chew processing method

(76) Inventor: Zhao-Chong Zhu, Ping Yang (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/103,778

(22) Filed: Mar. 25, 2002

(30) Foreign Application Priority Data
Mar. 31, 2001 (CN) 01 1 105819.6

(51) Int. Cl. A23L 1/31

(52) U.S. Cl. 426/641

(57) ABSTRACT

This invention is achieved by a pigskin dog chew processing method, which treats the semi-finished product-just like finished hide sheet or molded product in smoking processing to carry out coloring and tasting.

### BACKGROUND OF THE INVENTION

1. Field of the Invention

The present invention relates to a pet food processing method.

2. Description of Prior Art

Rawhide pet food is a kind of pet food, and named dog chew in the pet food manufacturing industry. Said dog chew is made of rawhide processed with defatting, hair eliminating treatments, then be split into the first, second, third and fourth rawhide sheets, next to be defatted, rinsed and basked sequentially to form finished hides, then they are processed with cutting, soaking, weaving, drying, coloring and tasting so as to obtain a finished rawhide dog chew; and in the other way, said finished hides are chopped into smash piece, and added and mixed with adhesive, then to be molded into desired shape, next to be dried and with color and taste to produce a finished bound dog chew, hence said dog chews can be divided into the rawhide and the bound dog chews-two kinds, according to their processing technique. On the other hand, in accordance with the raw material in manufacturing, said dog chews can be divided into cowhide and pigskin dog chews, therein said cowhide dog chew, because the cowhide has feathers of finer pore and lesser fat, has delicate shiny surface and easy coloring and tasting with variety of desired smell by soaking treatment, said coloring and tasting processes are to apply the method of making food pigment and monosodium glutamate act on the surface of said dog chews directly, which is suited to treat cowhide dog chews. But pigskin, due to thicker pore and richer fat, is looked rough surface, stiff, glossless, light pink and has strong original hide smell and oil smell, and is difficulty to be colored and tasted due to the fat coat at the surface. Therefore although the pigskin dog chews have sufficient material and great easier available source market relatively than the cowhide's, but also the pigskin dog chews can not be changed and overcame their disgusting original hide smell and fatty smell by the traditional coloring and tasting processing methods, so in the dog chew market the cowhide dog chews make up the absolute majority, but the pigskin dog chews just only obtain a little.

### OBJECTS AND SUMMARY OF THE INVENTION

It is therefore a main object of the present invention to provide a pigskin dog chew processing method, which can thoroughly overcome and change the original hide smell and color of said pigskin dog chews.

This object is achieved by a pigskin dog chew processing method, which treats the semi-finished product—just like finished hide sheet or molded product in smoking processing to carry out coloring and tasting.

Said pigskin dog chew processing method includes defatting and hair eliminating processing treatments on said raw pigskin, and splitting hide procedure for obtaining the first, second, third and fourth rawhide layer sheets, then passing through defatting, rinsing and drying processing treatments to form finished hides, by cutting, soaking, weaving and drying procedures, the products are finished, then by means of smoking processing, said products are colored and tasted so as to obtain finished pigskin dog chews.

Said pigskin dog chew processing method also can be in another way that is comprised of defatting and hair eliminating processing treatments on said raw pigskin, and splitting the hide for obtaining the first, second, third and fourth rawhide layer sheets, then passing through defatting, rinsing and drying processing treatments to form finished hides, by chopping up it into smash piece, mixing with additive adhesive, molding into shape, and drying procedures in sequent, the bound products are finished, then by means of smoking processing, said bound products are colored and tasted so as to obtain finished pigskin dog chews.

Because the character of the pigskin product has thicker pores with higher venting quality, and better heat-absorbing and smoke absorbability than the other rawhides like cowhide so that it absorbed with the smoke will have marvelous smell effect, meanwhile the rich fat attached on the surface of said pigskin product will act on the surface by heat-melting in smoking treatment to form a shiny protection coat as coloring, when the traditional coloring and tasting processing methods can not produce desired result. The present invention, except for, provides a smoking process to perform coloring and tasting effects, also thoroughly resolves the original product rich fat, difficultly processing, easily damping and mildewing problems.

### BRIEF DESCRIPTION OF THE DRAWINGS

FIG. 1 is a cross-section view showing the smoking equipment of the present invention.

### DETAILED DESCRIPTION OF PREFERRED EMBODIMENTS

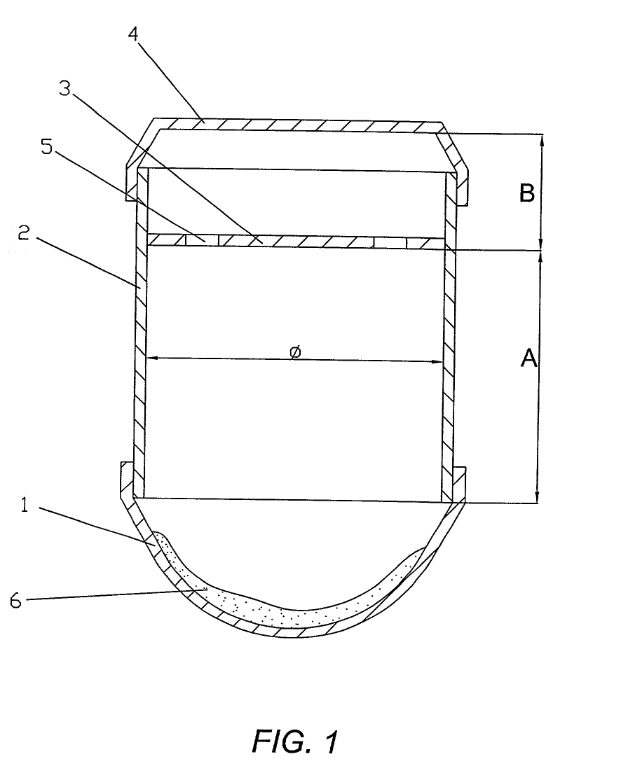

For overcoming the disgusting original color and smell of the traditional pigskin dog chews, said rawhide pigskin products or bound pigskin products can be put into a smoker 1 as showing in FIG. 1, which includes a smoke cage 2, a grid 3 and a cap 4, placing on the topside of said grid 3 of said smoke cage 2, meanwhile some fumigant 6 is put on the bottom of said smoker 1, when heating, the smoker 1 makes the fumigant 6 carbonize by overheat to generate heat smoke rising upward and passing through the air vents 5 on said grid 3 to get the inside of said cap 4, then along the rim side, flow back down to the grid 3 to form a heat smoke flow circle to absorb on and combine with said molded products located on the grid 3 so as to reach the goal of changing original color and smell of said pigskin dog chews. In the heat-smoke flow circle, heated smoke flows up and cooled flows down so that the smoke stream continuously touches and penetrates the goods to generate crystal absorbing on the inside of the material, meanwhile it can prevent the goods from overheating to be carbonized.

When smoking, the temperature born by said pigskin dog chew product should not be over high or over low, if not, the goods will be carbonized or not be smoked into desired effect, therefore the inventor concludes many results of experiments to induce the following exercising data: when the diameter of said smoke cage 2 is in 50 cm to 120 cm range, the distance from the bottom of said smoker 1 to the grid 3 is about 20 cm so that the heated smoke steam flows up at least 20 cm to get the smoked objects to guarantee the temperature surrounding the goods from over high and avoid the smoked objects carbonized; meanwhile the distance from the grid 3 to the cap 4 is not less than 25 cm so that the smoke steam has basic flowing back space for preventing the temperature of flow-back smoke steam from being cooled over low, therefore guaranteeing the smoking effect, during the smoking treatment, the smoked objects reacts with said smoke thoroughly just as the stream flows back after touching the cap. Referring to FIG. 1, in the embodiment, when the diameter Φ of said smoke cage 2, the distance A from the bottom of said smoker 1 to the grid 3 and the distance B from the grid to the cap 4 are respectively 78 cm, 30 cm and 15 cm, the smoking effect can be guaranteed in the better level.

Said fumigant used in the smoking processing is consisted of a sort of amyloidal fumigant—like potato shreds or grain or rice, mixing with a sort of carbohydrate fumigant—like red granulated sugar or original sugar or yellow sugar or pellet sugar, therein when said amyloidal fumigant should hold from 55% to 65% of total quantity, and said carbohydrate fumigant accounts for from 45% to 35%, the smoking process will get a better effect. During the smoking processing, the main elements of the starch and sugar of the mixed fumigant are carbonized by overheating and oxygen less to create good smelled smoke of the baked starch and sugar filling out all the space at the inside of said smoker 1, additionally higher temperature in the inside of said smoke cage 2, the surface of the goods is roasted, meanwhile the strenuous molecule moving enhance the smoke containing elements of sugar and starch to absorb on the goods in better, further to change the color and smell and taste of the goods and to make the goods golden and with a bit charming sweet. For a long term studying, the inventor find the fumigant consisted of 60% potato shreds and 40% red granulated sugar may get a desired result.

I claim:

1. A pigskin dog chew processing method includes degreasing and hair eliminating processing treatments on said raw pigskin, and splitting hide procedure for obtaining the first, second, third and fourth rawhide layer sheets, then passing through defatting, rinsing and drying processing treatments to form finished hides, by cutting, soaking, weaving and drying procedures, the products are finished, then by means of smoking processing, said products are colored and tasted so as to obtain finished pigskin dog chews.

2. A pigskin dog chew processing method as claimed in claim 1,
wherein said smoking process employs a fumigator including a smoker 1, a smoke cage 2, a grid 3 and a cap 4, said pigskin products can be put into a smoker 1 placing on the topside of said grid 3 of said smoke cage 2, meanwhile some fumigant 6 is put on the bottom of said smoker 1, when heating, the smoker 1 makes the fumigant 6 carbonize by overheat to generate heatsmoke stream rising up to get the inside of said cap 4, then along the rim side, flow back down to the grid 3 to form a heat smoke flow circle to absorb on and combine with said products located on the grid 3 to form a finished product.

3. A pigskin dog chew processing method as claimed in claim 2,
wherein when the diameter of said smoke cage is in 50 cm to 120 cm range, the distance from the bottom of said smoker to the grid is or more than 20 cm, so that the heated smoke steam flows up at least 20 cm to get the smoked objects to guarantee the temperature surrounding the goods from over high and avoid the smoked objects carbonized; meanwhile the distance from the grid to the cap is not less than 25 cm.

4. A pigskin dog chew processing method as claimed in claim 2,
wherein said fumigant is consisted of a sort of amyloidal fumigant—like potato shreds or grain or rice, mixing with a sort of carbohydrate fumigant—like red granulated sugar or original sugar or yellow sugar or pellet sugar, therein when said amyloidal fumigant should hold from 55% to 65% of total quantity, and said carbohydrate fumigant accounts for from 45% to 35%.

5. A pigskin dog chew processing method as claimed in claim 3,
wherein said fumigant is consisted of a sort of amyloidal fumigant—like potato shreds or grain or rice, mixing with a sort of carbohydrate fumigant—like red granulated sugar or original sugar or yellow sugar or pellet sugar, therein when said amyloidal fumigant should hold from 55% to 65% of total quantity, and said carbohydrate fumigant accounts for from 45% to 35%.

6. A pigskin dog chew processing method as claimed in claim 4,
wherein said fumigant is consisted of potato shreds and red granulated sugar, within said potato holding 60% of total quantity, and said red granulated sugar accounts for 40%.

7. A pigskin dog chew processing method as claimed in claim 5,
wherein said fumigant is consisted of potato shreds and red granulated sugar, within said potato holding 60% of total quantity, and said red granulated sugar accounts for 40%.

8. A pigskin dog chew processing method includes defatting and hair eliminating processing treatments on said raw pigskin, and splitting hide procedure for obtaining the first, second, third and fourth rawhide layer sheets, then passing through defatting, rinsing and drying processing treatments to form finished hides, by chopping up it into smash piece, mixing with additive adhesive, molding into shape, and drying procedures in sequent, the bound products are finished, then by means of smoking processing, said bound products are colored and tasted so as to obtain finished pigskin dog chews.

9. A pigskin dog chew processing method as claimed in claim 8,
wherein said smoking process employs a fumigator including a smoker 1, a smoke cage 2, a grid 3 and a cap 4, said molded pigskin products can be put into a smoker 1 placing on the topside of said grid 3 of said smoke cage 2, meanwhile some fumigant 6 is put on the bottom of said smoker 1, when heating, the smoker 1 makes the fumigant 6 carbonize by overheat to generate heatsmoke stream rising up to get the inside of said cap 4, then along the rim side, flow back down to the grid 3 to form a heat smoke flow circle to absorb on and combine with said molded products located on the grid 3 to form a finished product.

10. A pigskin dog chew processing method as claimed in claim 9,
wherein when the diameter of said smoke cage is in 50 cm to 120 cm range, the distance from the bottom of said smoker to the grid is or more than 20 cm so that the heated smoke steam flows up at least 20 cm to get the smoked objects to guarantee the temperature surrounding the goods from over high and avoid the smoked objects carbonized; meanwhile the distance from the grid to the cap is not less than 25 cm.

11. A pigskin dog chew processing method as claimed in claim 9,
wherein said fumigant is consisted of a sort of amyloidal fumigant—like potato shreds or grain or rice, mixing with a sort of carbohydrate fumigant—like red granulated sugar or original sugar or yellow sugar or pellet sugar, therein when said amyloidal fumigant should hold from 55% to 65% of total quantity, and said carbohydrate fumigant accounts for from 45% to 35%.

12. A pigskin dog chew processing method as claimed in claim 10,
wherein said fumigant is consisted of a sort of amyloidal fumigant—like potato shreds or grain or rice, mixing with a sort of carbohydrate fumigant—like red granulated sugar or original sugar or yellow sugar or pellet sugar, therein when said amyloidal fumigant should hold from 55% to 65% of total quantity, and said carbohydrate fumigant accounts for from 45% to 35%.

13. A pigskin dog chew processing method as claimed in claim 11,
wherein said fumigant is consisted of potato shreds and red granulated sugar, within said potato holding 60% of total quantity, and said red granulated sugar accounts for 40%.

14. A pigskin dog chew processing method as claimed in claim 12,
wherein said fumigant is consisted of potato shreds and red granulated sugar, within said potato holding 60% of total quantity, and said red granulated sugar accounts for 40%.
